(19) United States
(12) Patent Application Publication
(10) Pub. No.: US 2005/0052974 A1
(43) Pub. Date: Mar. 10, 2005

(54) Optical disc apparatus

(75) Inventors: Atsushi Iida, Tokyo (JP); Takakiyo Kanazawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/898,361

(22) Filed: Jul. 26, 2004

(30) Foreign Application Priority Data
Aug. 1, 2003 (JP) 2003-285269

(51) Int. Cl. G11B 7/00

(52) U.S. Cl. 369/47.38; 369/44.37

(57) ABSTRACT

In an optical disc apparatus 1, an optical pickup 10a for CD/DVD combo and an optical pickup 10b for BD are fixedly disposed across a spindle motor 12 so as to face each other, and the spindle motor 12 is shifted between the first and second optical pickups 10a and 10b by a feeding mechanism constituted by a ball screw 15, drive motor 16, guide shaft 17, and the like.

### BACKGROUND OF THE INVENTION

1. Field of the Invention

The present invention relates to an optical disc apparatus capable of recording/reproducing data onto or from various types of optical discs such as a CD (Compact Disc), a DVD (Digital Versatile Disc), or a BD (Blu-ray Disc).

2. Description of the Related Art

Currently, different types of optical discs, such as CD, DVD, and BD which is a next-generation optical disc, have been proposed. They have different recording densities, use different recording formats, and are accordingly incompatible with each other. These optical discs have different basic physical parameters. More specifically, the laser wavelengths of CD, DVD, and BD are 780 nm, 650 nm, and 405 nm, respectively and the cover layer thicknesses of them are, 1.2 mm, 0.6 mm, and 0.1 mm, respectively. However, optical disc apparatuses are required to be capable of recording/reproducing data onto or from such various types of optical discs.

As a first method for recording/reproducing data onto or from different types of optical discs by using a single optical disc apparatus, a technique based on, for example, the brochure of PCT Application Laid-Open Publication No. 97/42632, in which two objective lenses, a dual-wavelength compliant objective lens for CD/DVD and objective lens for BD, are mounted on a single biaxial actuator is conceivable. As shown in FIG. 1, a dual-wavelength compliant objective lens 111a for CD/DVD and an objective lens 111b for BD are mounted on a single biaxial actuator 112. In this case, although there is a possibility that optical devices in a light source and an optical pickup 110 require the additional parts corresponding to respective wavelengths, at least, the single biaxial actuator 112 can be shared between the two objective lens 111a and 111b. Therefore, the optical pickup 110 can be disposed on one side of a spindle motor 113, so that it is only necessary that one feeding mechanism be provided for the optical pickup 110. As a result, it is possible to keep the size of the apparatus in the depth direction thereof.

Further, as a second method, it is possible to oppositely dispose an optical pickup 120a for CD/DVD combo and an optical pickup 120b for BD, each of which has its own feeding mechanism, across a fixed spindle motor 123, as shown FIG. 2. Under the circumstance, each of the optical pickups 120a and 120b is moved along a guide shaft 124.

However, in the case of the first method, difference in the working distance between the end of objective lens and a signal recording surface of the optical disc occurs depending on the types of the optical discs, so that the working distance must be adjusted for each disc.

Further, the mounting of the two objective lenses 111a and 111b on the single biaxial actuator 112 increases weight of a moving part, resulting in deterioration of dynamic performance of the biaxial actuator 112.

Further, the second method involving two feeding mechanisms increases the size of the optical disc apparatus in the depth direction (direction along the guide shaft) thereof.

### SUMMARY OF THE INVENTION

The present invention has been made in view of the above circumstances, and an object thereof is to provide a compact optical disc apparatus capable of recording/reproducing data onto or from different types of optical discs such as CD, DVD, or BD, and applicable not only to a storage for AV equipments, but also to a built-in storage for PC.

To solve the above object, according to the present invention, there is provided an optical disc apparatus comprising: a rotation operation means for rotating an optical disc while holding a central portion of the optical disc; first and second optical pickups which are oppositely disposed across the rotation operation means and which respectively have first and second light focusing means, first and second light sources which irradiate the first and second light focusing means with luminous fluxes, first and second photodetectors which detect luminous fluxes, the luminous fluxes being emitted from the first and second light sources, focused on a signal recording surface of the optical disc by the first and second light focusing means, and reflected by the signal recording surface; and a shift means for shifting the rotation operation means between the first and second optical pickups.

In the above optical disc apparatus, the first and second optical pickups are disposed across the rotation operation means so as to face each other, and the rotation operation means is shifted between the first and second optical pickups by the shift means.

In the optical disc apparatus according to the present invention, as described above, the first and second optical pickups are disposed across the rotation operation means so as to face each other, and the rotation operation means is shifted between the first and second optical pickups by the shift means. Therefore, the size of the optical disc apparatus can be reduced further than in the case where the shift means are provided for each of the first and second optical pickups, allowing the optical disc apparatus to be applied to a built-in storage for PC.

### BRIEF DESCRIPTION OF THE DRAWINGS

FIG. 1 is a view showing a first example of a conventional optical disc apparatus capable of recording/reproducing data onto or from CD, DVD and BD;

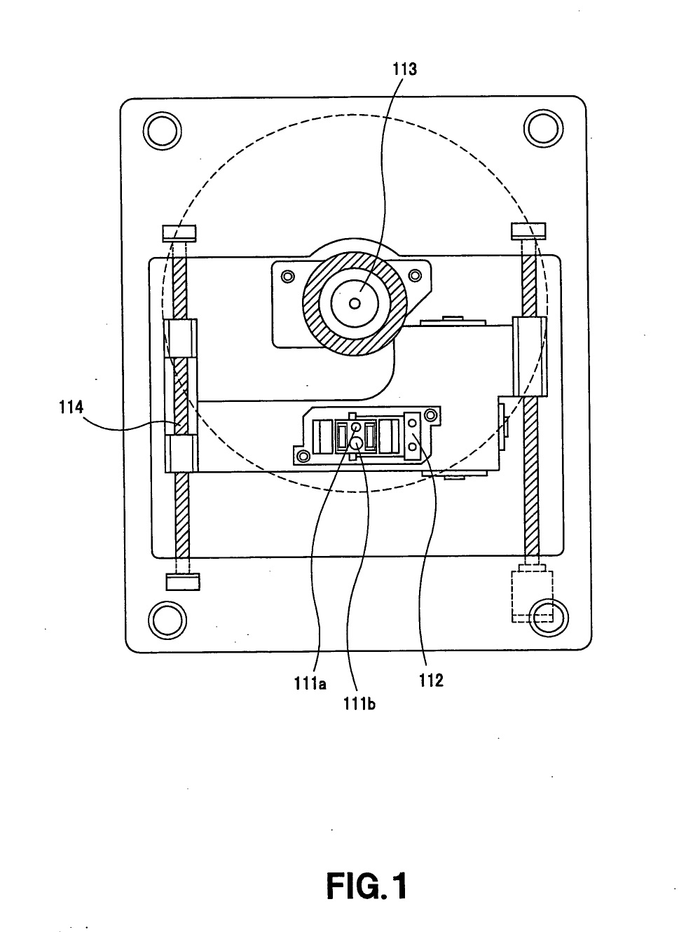

FIG. 2 is a view showing a second example of a conventional optical disc apparatus capable of recording/reproducing data onto or from CD, DVD and BD; and

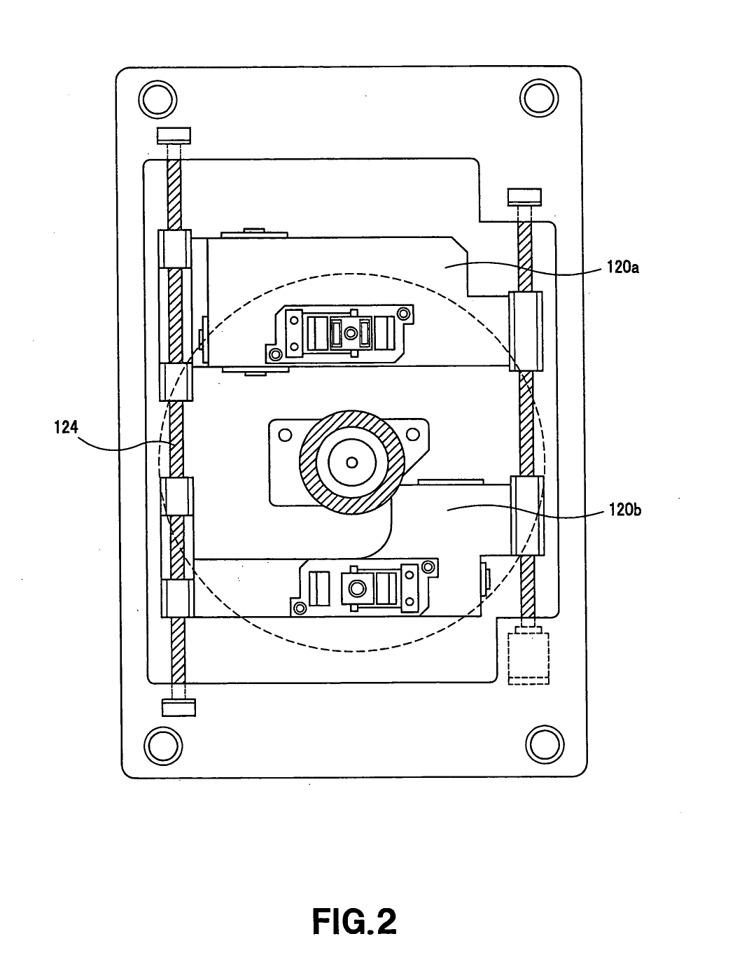

FIG. 3 is a view schematically showing a configuration of an optical disc apparatus according to an embodiment of the present invention.

### DETAILED DESCRIPTION OF THE PREFERRED EMBODIMENTS

An embodiment of the present invention will be concretely described below with reference to the accompanying drawings. In this embodiment, the present invention is applied to an optical disc apparatus which records/reproduces data onto or from different types of optical discs such as CD, DVD, or BD.

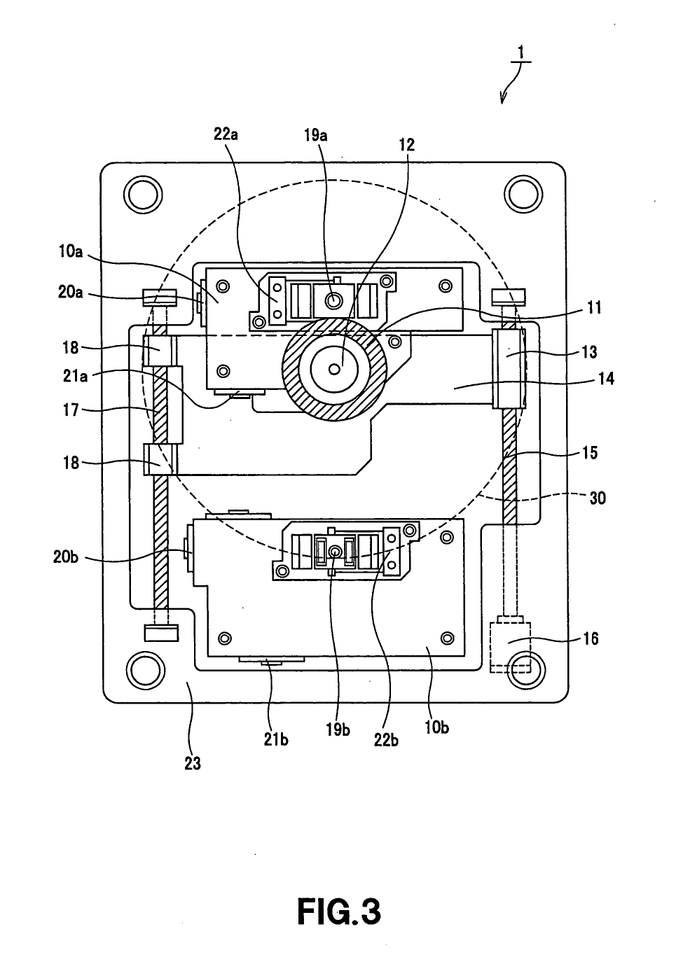

FIG. 3 schematically shows a configuration of an optical disc apparatus according to the embodiment. An optical disc apparatus 1 according to the embodiment comprises, on a chassis 23, an optical pickup 10a for e.g., CD/DVD combo, an optical pickup 10b for e.g., BD, a turntable 11 which cramps an optical disc 30, a spindle motor 12 which rotates the optical disc 30, a spindle motor base 14 provided with a lead nut 13, a drive motor 16 provided with a ball screw 15, a guide shaft 17, and a bearing 18. A feeding mechanism of the spindle motor 12 is constituted by the lead nut 13, spindle motor base 14, ball screw 15, drive motor 16, guide shaft 17 and bearing 18.

The optical pickups 10a and 10b have objective lenses 19a and 19b serving as a light focusing means, light sources 20a and 20b from which laser beams with wavelengths corresponding to respective optical disc systems are radiated onto the objective lenses 19a and 19b, respectively, and photodetectors 21a and 21b serving as a light-sensitive detector. The optical pickups 10a and 10b are controlled by biaxial actuators 22a and 22b provided with the objective lenses 19a and 19b so as to allow the laser beams from the optical pickups 10a and 10b to be focused on a signal recording surface of the optical disc 30 and to follow a desirable recording track. Reflected lights from the signal recording surface including signal components are passed through the objective lenses 19a and 19b, and incident on the optical pickups 10a and 10b, followed by being detected by the photodetectors 21a and 21b.

In order to allow laser spots to follow a desired recording track of the optical disc 30, relative position between the optical pickups 10a, 10b, and the spindle motor 12 must be sent with coarse accuracy or shifted at high velocities by means of the optical pickups 10a, 10b.

That is, when CD or DVD is used as the optical disc 30, the optical disc 30 must be shifted in the direction toward the optical pickup 10a. On the other hand, when BD is used as the optical disc 30, the optical disc 30 must be shifted in the direction toward the optical pickup 10b.

To this end, in the optical disc apparatus 1 according to the embodiment, the aforementioned feeding mechanism of the spindle motor 12 is used to convert rotational movement of the ball screw 15, which is generated by the drive motor 16, into linear movement by means of the lead nut 13, thereby shifting the spindle motor base 14 provided with the lead nut 13 between two optical pickups 10a and 10b along the guide shaft 17.

In this case, the spindle motor 12 having the feeding mechanism and two optical pickups 10a and 10b are disposed so that the optical pickups 10a and 10b are capable of realizing recording/reproduction operation from the innermost to outermost circumference of the signal recording surface of the optical disc 30. More specifically, as shown in FIG. 3, the positional relationship among the spindle motor 12 and two optical pickups 10a and 10b is defined so as to enable the optical pickup 10b to execute recording/reproduction operation for the outermost circumference of the optical pickup 30 in a state where the optical pickup 10a is capable of executing recording/reproduction operation for the innermost circumference of the optical disc 30, and enable the optical pickup 10b to execute recording/reproduction operation for the innermost circumference of the optical disc 30 in a state where the optical pickup 10a is capable of executing recording/reproduction operation for the outermost circumference of the optical disc 30.

As has been described above, in the optical disc apparatus 1 according to the embodiment, the optical pickup 10a for CD/DVD combo and optical pickup 10b for BD are oppositely disposed across the spindle motor 12, and the spindle motor 12 is shifted between the optical pickups 10a and 10b by the feeding mechanism. As a result, recording/reproduction operation for CD, DVD, and BD can be realized in a single apparatus.

In particular, instead of attaching feeding mechanisms to each of the optical pickups 10a and 10b, the feeding mechanism is attached to the spindle motor 12. Therefore, it is only necessary that one feeding mechanism be provided in the optical disc apparatus 1, thereby reducing the size of the apparatus 1 in the depth direction (direction along the guide shaft 17).

The present invention is not limited to the above embodiment, and can be variously modified without departing from the spirit and scope of the invention.

1. An optical disc apparatus comprising:
rotation operation means for rotating an optical disc while holding a central portion of the optical disc;
first and second optical pickups which are oppositely disposed across the rotation operation means and each of which has light focusing means, a light source which generates light beams with a wavelength 1 or more, a photodetector which detects a luminous flux, the luminous flux being emitted from the light source, focused on a signal recording surface of the optical disc by the light focusing means and reflected by the signal recording surface; and
shift means for shifting the rotation operation means between the first and second optical pickups.

2. The optical disc apparatus according to claim 1, wherein
the first and second optical pickups have light sources which emit luminous fluxes having different wavelengths from each other.

3. The optical disc apparatus according to claim 1, wherein
the first and second optical pickups are disposed on the position at which,
in a state where the light focusing means of the first optical pickup is capable of focusing light on the innermost circumference of the signal recording surface, the light focusing means of the second optical pickup is capable of focusing light on the outermost circumference of the signal recording surface, and
in a state where the light focusing means of the first optical pickup is capable of focusing light on the outermost circumference of the signal recording surface, the light focusing means of the second optical pickup is capable of focusing light on the innermost circumference of the signal recording surface.
